(19) United States
(12) Patent Application Publication
(10) Pub. No.: US 2010/0318798 A1
(43) Pub. Date: Dec. 16, 2010

(54) MESSAGE HANDLING AT A MOBILE DEVICE

(75) Inventors: Carl Binding, Rueschlikon (CH); Francois Bernard Dolivo, Wasdenswil (CH); Reto Josef Hermann, Buttikon (CH); Dirk Husemann, Einsiedein (CH)

Correspondence Address: Anne Vachon Dougherty, 3173 Cedar Road, Yorktown Hts, NY, 10598, US

(73) Assignee: International Business Machines Corporation, Armonk, NY (US)

(21) Appl. No.: 12/345,696

(22) Filed: Dec. 30, 2008

(30) Foreign Application Priority Data
Jun. 30, 2006 (EP) 06116410.9
Jun. 28, 2007 (IB) PCT/IB2007/052511

(51) Int. Cl. H04L 9/00; G06F 21/00

(52) U.S. Cl. 713/170; 713/193; 713/176

(57) ABSTRACT

A method for sending a message from a mobile device via a first application running on the mobile device is proposed. The method comprises a challenge step for supplying the first application with a challenge, a response step for receiving a response to the challenge, an equality check step for determining whether the received response corresponds to an expected response, a signature step for providing a signature for the message, using a cryptographic key and the result of the equality check step, and a send step for sending the signed message via the first application from the mobile device to a backend system.

### TECHNICAL FIELD

The present invention relates to a method for sending a message from a mobile device via an application running on the mobile device. It also relates to a method for receiving a message at a mobile device. It furthermore relates to a mobile device and a smart card.

### BACKGROUND OF THE INVENTION

Building integrated systems comprising both backend/infrastructure components as well as embedded system components poses, among other things, the problem of ensuring end-to-end system integrity. In such integrated systems, the backend system relies on the data emanating from embedded sensor components to be correct and untampered with.

Ensuring integrity of a backend system is a known problem and various mechanisms and measures are available and typically in place to secure a system and to ensure system integrity. Also, backend systems are usually installed in a fixed physical location that can also be physically secured, and physical access to the system can be monitored. In contrast, embedded components are often mobile, have limited resources and are harder to guard. Physical access to those embedded components very often cannot be controlled or restricted. For example, an embedded system can be mounted on a car, and anyone able to approach the car can gain access to the embedded system itself.

The problem is hence to ensure system integrity, i.e. to make sure that an application image has not been tampered with in an environment that comprises on one side a backend system, and on the other end a mobile device. The integrity is useful to ensure that messages sent between the backend system and the mobile device can be trusted as coming from an integer source.

It is known to use special processors that have integrated crypto components or use integrated smart cards, such as the Trusted Computing Group's (TCG) Trusted Platform Module (TPM) mechanism, where the security component has access to the state of the CPU and can passively monitor memory accesses, for example, or rely on checksums over the application image and compare those checksums with a precalculated checksum stored in the application image. The first approach is relatively costly from a hardware perspective and only viable for large volumes, the latter approach is defeatable by reverse engineering of the application image.

It is therefore a challenge to provide a method for sending messages from a mobile device to a backend system that overcomes the above mentioned drawbacks.

### SUMMARY OF THE INVENTION

According to one aspect of the invention a method is provided for sending a message from a mobile device via a first application running on the mobile device, the method comprising a challenge step for supplying the first application with a challenge, a response step for receiving a response to the challenge, an equality check step for determining whether the received response corresponds to an expected response, a signature step for providing a signature for the message, using a cryptographic key and the result of the equality check step, and a send step for sending the signed message via the first application from the mobile device to a backend system. With the above process the first application is tested on its integrity and the result of this test influences the signature of a message that is sent to the backend system. A backend system is here understood as a system that is physically separated from the mobile device and that has a communication connection to the mobile device. In a preferred embodiment such backend system could comprise any functionality of controlling the mobile device, storing data coming from or being sent to the mobile device, tracking the mobile device, performing checks on the mobile device, updating software on the mobile device, processing data coming from or being sent to the mobile device, sending data coming from the mobile device to other systems, etc.

In a preferred embodiment the message is modified in a message amendment step with the result of the equality check step, before the signature step. This step has the advantage that it can be carried out transparent to the first application, in particular if the message is not only amended but also encrypted before sending it. Then the first application will even if its non-integrity has been detected, not be able to itself detect the message amendment signalling its non-integrity to the backend, and based on its assumption that everything is running as normal, i.e. as if it was integer, deliver the message to the backend system.

In a preferred embodiment the message is modified by adding the result of the equality check step to the message. This has the advantage that the original content of the message delivered will be unchanged and that still the recipient will be able to determine the non-integrity of the sending first application. Also, this kind of message amendment is technically easy to realize.

In a preferred embodiment the message itself carries any kind of information, wherein the information does not contain any information about security, authenticity or integrity of the first application. The above method is hence suited to modify a message that itself in the event of an integer first application is unamended. Hence the advantage arises, that for integer first applications the mechanism of transporting messages to and from the mobile device is, with exception of a possible delay due to the integrity check, not different from that mechanism being carried out without any integrity check. On the other hand, the advantage arises that in the event of a non-integer first application the recipient of the message can learn about the integrity issue, with the information about that issue being piggybacked upon the message. The mobile device itself can act as transporter of the information about its own non-integrity. To enable this in an advantageous manner, the method is able to be carried out without the first application realizing that its lack of integrity has been detected. As such the integrity information can be passed by the first application in a transparent manner.

In a preferred embodiment the message is encrypted using the private key of the private/public key pair stored on a smart card. Hereby the advantage is achieved that a well-known mechanism of using an asymmetric key can be leveraged to enhance security. Smart cards with private/public key pairs stored thereon are state of the art, and hence mechanisms exist to provide an enhanced level of tamper-proofness, making it harder for attackers to gain access to the private key. Hence smart card technology can be used to harden the security of the mobile device. At the same time the smart card need not be equipped to perform services like processing sensor data, or sending and receiving messages to or from a backend system.

In a preferred embodiment the cryptographic key is held on a smart card. In an even more preferred embodiment the cryptographic key is selected to comprise the private key of the private/public key pair stored on a smart card. For the same reason as above in reference to the private/public key pair, also the cryptographic key for signature can be stored on the smart card and make use of its increased level of security. It is also possible to use the private key of the private/public key pair as the cryptographic key, thereby reducing the amount of stored data, and number of keys. Using a cryptographic key that is different from the private key on the other hand increases security, since an attacker would need to break two keys to get access to the message, or modify it.

According to a second aspect of the invention, a method is provided for receiving a message at a mobile device via a first application running on the mobile device, the method comprising a message reception step for receiving the message in an encrypted form, a challenge step for supplying the first application with a challenge, a response step for receiving a response to the challenge, an equality check step for determining whether the received response corresponds to an expected response, if the result of the equality check step is positive, a message decryption step for decrypting the message, if the result of the equality check step is negative, an error generation step. The advantages explained in conjunction with the first aspect also hold true for this second aspect. Again, the first application only can continue its operation if its integrity has been confirmed. Otherwise it gets no access to the message. The integrity check is performed outside of the first application and hence the first application can not itself circumvent this security operation.

In a preferred embodiment the encrypted form has been created under use of the public key of a private/public key set stored on a smart card. By this step the increased security offered by known smart cards with private/public key sets can be exploited. Such security level can be set in a way that an attacker using known hacking methods to try to access a private key on a smart card, can not access this key within the lifetime of the mobile device.

In a preferred embodiment the encrypted form has been created under use of a symmetric cryptographic key which is received together with the message, wherein the symmetric cryptographic key is received in encrypted form, wherein the encrypted form has been created under use of the public key of a private/public key set stored on a smart card. The symmetric cryptographic key works here as a session key which, however, is only accessible by the first application once it has been unpacked by the smart card. Again the enhanced security by private/public key encryption on the smart card protects the content of the message until integrity of the first application has been confirmed. The use of the session key reduces the amount of work to be conducted by the smart card. After having confirmed the integrity the decryption of the message can be conducted by the first application itself, using the unpacked session key. This step is computationally more intensive than the session key unpacking i.e. decryption, and hence uses more time and as such more energy. To reduce power consumption, the smart card power can be shut off or reduced after the decryption of the session key, and only the mobile device with its running first application uses energy to continue its operation.

In a preferred embodiment the challenge and the expected response are selected from a set of predetermined challenges/expected responses. Hereby the risk of the first application trying to circumvent the integrity check by precomputing the expected hash value is reduced. The larger the set of predetermined challenges/expected responses, the less likely it is that the first application succeeds in creating a response that corresponds to the expected response despite the first application image not being integer.

In a preferred embodiment the challenge step and the response step are executed by means of an integrity applet on a smart card. This is advantageous because these steps are then performed in a more secure computing environment in comparison to doing this on the first CPU 20, where the first application could influence these steps.

In a preferred embodiment the challenge step comprises a request to compute a hash value of a predetermined memory area in a memory of the mobile device. The advantage hereof is that the computation of a hash value is technically rather simple while it provides a way of identifying even single-bit deviations from an integer memory area.

In a preferred embodiment the memory area is selected to comprise at least part of a first application image of the first application. By this selection the targeted first application is checked right in the non-volatile memory, hence in an advantageous manner the likelihood of integrity-change detection is increased.

In a preferred embodiment the memory area is determined by a start address and an end address, the memory area differing between different challenges of the set of predetermined challenges/expected responses. This selection provides an advantageously simple means of devising different challenges, since the start address and end address provide a parameter of the first application image that provides relatively many selection variations.

In a preferred embodiment the result of the equality check step, if negative, is maintained as a negative integrity flag. To do so is advantageous since a once non-integer first application is thereby prevented from returning to an integer state, disallowing a non-integer first application to undertake measures to try to mask its lasting non-integrity by reestablishing an integer first application image.

In another preferred embodiment the negative results of the equality checks are stored along with the respective challenges. The advantage of doing so is that it is then possible to derive which parts of the application have been tampered with.

In a preferred embodiment the first application is updatable via the first communication module of the mobile device, such that the advantage occurs that the mobile device need not be present at a predetermined location to perform an update of the first application.

In a preferred embodiment the updated first application is stored in a second application image. This allows the advantageous feature of updating a first application by switching from the first application image to the second application image. Naturally this can be continued by storing a yet next update in the storage space of the first application image, and switching again to that update. This switching can be effectuated by maintaining version numbers and having the CPU use the higher of those numbers as indicator where the most recent update is stored.

In a preferred embodiment the updated first application is received together with an updated set of challenges/expected responses. This way not only application updates but at the same time the corresponding challenges/expected responses for the integrity check can be loaded which provides a time advantage. If the update is sent via the communication modules, a remote update is possible in complete form, keeping the mobile device at an arbitrary place just within reach distance of the communication modules.

In a preferred embodiment the method further comprises an acknowledgment step wherein after the equality check step the reception of the response is acknowledged without communicating the result of the equality check step. Such acknowledgment step has the advantage that the first application is kept in an information state that does not reveal the result of the integrity check. Thereby the integrity step and any eventual consequence are kept transparent from the first application. The acknowledgment step is hence an element of the integrity applet pretending that everything is OK and that the challenge-response procedure succeeded with a positive result. The first application is thereby kept uninformed and has no reason to perform any action that could harm the mobile device, the message, or the backend system or any other system attached, or delay sending the message and thereby delay the detection.

According to a third aspect of the invention, a computer program element is provided comprising computer program code means which, when loaded in a processor of a data processing system, configures the processor to perform the described methods. Advantageously the method can be programmed into such data processing system, wherein the method for sending a message from a mobile device via a first application running on the mobile device would be programmed into a smart card data processing system. The method for sending receiving a message from at a mobile device via a first application running on the mobile device would also be programmed into a smart card data processing system.

The computer program element can also be provided in form of a computer program product comprising a computer-readable medium embodying program instructions executable by a processor to perform a method as described.

According to a third aspect of the invention a mobile device is provided comprising a memory for storing therein a first application image of a first application, a first processor adapted to compute a response to a received challenge, a card reader for receiving from a smart card the challenge, sending the response, and receiving a signed message, and a first communication module for sending the signed message to a backend system.

According to a fourth aspect of the invention a smart card is provided comprising stored therein an integrity applet for executing a challenge step for supplying a first application with a challenge, a response step for receiving a response to the challenge, an equality check step for determining whether the received response corresponds to an expected response, an electronic signature applet for executing a signature step for signing a message, using a cryptographic key and the result of the equality check step, and a signature forwarding step for forwarding the signature for the message to a first communication module.

In a preferred embodiment the integrity applet is further adapted for executing an acknowledgement step wherein after the equality check step the reception of the response is acknowledged without communicating the result of the equality check step.

In yet a preferred embodiment the smart card further comprises a private/public key pair of which the public key is usable as the cryptographic key.

In yet another preferred embodiment the smart card further comprises a set of predetermined challenges/expected responses, from which the challenge and its expected response are selectable.

In still another preferred embodiment the smart card further comprises an integrity flag in which the result of the equality check step, if negative, is maintained.

### BRIEF DESCRIPTION OF THE DRAWINGS

The invention and its embodiments will be more fully appreciated by reference to the following detailed description of presently preferred but nonetheless illustrative embodiments in accordance with the present invention when taken in conjunction with the accompanying drawings.

The figures are illustrating:

FIG. 1, a schematic diagram illustrating a backend system in communication with a mobile device;

FIG. 2, an example of the partitions of a non-volatile memory;

FIG. 3, a schematic diagram illustrating the functional components of a mobile device;

FIG. 4, a flowchart of a method for sending a message from a mobile device to a backend system with a tampered first application;

FIG. 5, a flowchart of a method for sending a message from a mobile device to a backend system with an untampered first application;

FIG. 6, a flowchart of a method for receiving a message at the mobile device from the backend system with an untampered first application;

FIG. 7, a flowchart of a method for receiving a message at the mobile device from the backend system with a tampered first application.

### DETAILED DESCRIPTION OF THE DRAWINGS

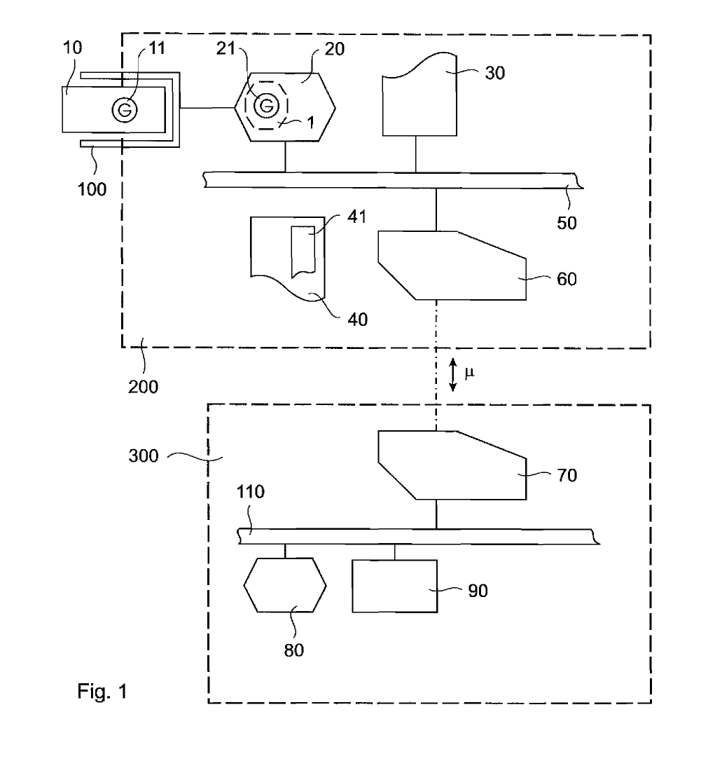

FIG. 1 shows a mobile device 200 that comprises a computing environment which contains a memory 40, hereinafter referred to as a non-volatile memory 40, a first communication module 60, a first main memory 30, also referred to as first RAM 30, and a first processor 20, also referred to as first CPU 20, all attached to a first data/address bus 50. The first CPU 20 is also connected to a card reader 100 for reading a smart card 10 when inserted.

A smart card, chip card, or integrated circuit card, is here understood as a pocket-sized card with embedded integrated circuits. The smart card 10 is also referred to as microprocessor card, containing a card memory and microprocessor components. In particular, as smart card 10 can be used a microprocessor card of credit card dimensions, or smaller, e.g. the GSM SIM card, with tamper-resistant properties, e.g. a secure crypto-processor, secure file system, human-readable features, and is capable of providing security services, e.g. confidentiality of information in its card memory.

The mobile device 200 can be in a preferred embodiment an embedded platform where a first application image 41 is stored in the non-volatile memory 40, such as a FLASH RAM, EEPROM, ROM, PROM, RAM, DRAM, SRAM, flash, firmware, or programmable logic. The non-volatile memory 40 may comprise an internal storage device, an attached storage device and/or a network accessible storage device. An embedded platform can comprise in addition to the computing environment described one or more sensors whose signals can be processed within the mobile device 200.

The mobile device 200 can connect to a backend system 300 comprising a computing environment which contains a second communication module 70, a second main memory 90, also referred to as second RAM 90 and a second processor 80, also referred to as second CPU 80, all attached to a second data/address bus 110.

The first communication module 60 and the second communication module 70 are adapted to communicate with each other.

The first CPU 20 loads a first application 1 from the non-volatile memory 40 on which the corresponding first application image 41 is stored. This first application 1 can for instance comprise the processing of sensor signals of a sensor. The first main memory 30 is the place where the data processed by the first CPU 20 are stored. In a preferred embodiment the mobile device 200 sends messages μ to the backend system 300, for instance messages μ containing results of processing sensor signals. For the backend system 300 it is desirable to be able to rely on the integrity of the received messages μ. Since the mobile device 200 is typically situated remotely and hence outside the control of the backend system 300, the backend system 300 has no or only limited possibility to ascertain that the mobile device 200 has not been accessed by an unauthorized person who could change the first application image 41 and thereby modify the first application 1 and hence modify the processing of the sensor signals. As a consequence the message μ could contain data that are no longer the data that the original, unamended first application 1 would have produced. In the following, such unauthorized intrusion into the first application 1 is referred to as tampering, whereby the integrity of the first application 1 is destroyed. The entity performing such intrusion is referred to as intruder. It is desired to detect such tampering and to notify the backend system 300 of such detected tampering in order to allow the backend system 300 to react to the tampering. The notification can occur via the communication link between the first communication module 60 and the second communication module 70. It is a challenge to send such notification via the first communication module 60, since the intruder could interfere with such communication to conceal its tampering activity to make the backend system 300 not realize that a tampering has occurred. The smart card 10 contains an integrity applet 11 that collaborates with an integrity module 21 that is part of the first application 1. The integrity applet 11 and the integrity module 21 together perform a process that allows the smart card 10 to test the integrity of the first application image 41. The result of this test is then embedded in the message μ that is sent to the backend system 300.

Possible reactions by the backend system 300 to the notified tampering are to ignore the message μ and any future messages form the mobile device 200, or to disable the mobile device 200, or to send an updated application image to reestablish an untampered first application image 41, or to perform other activities.

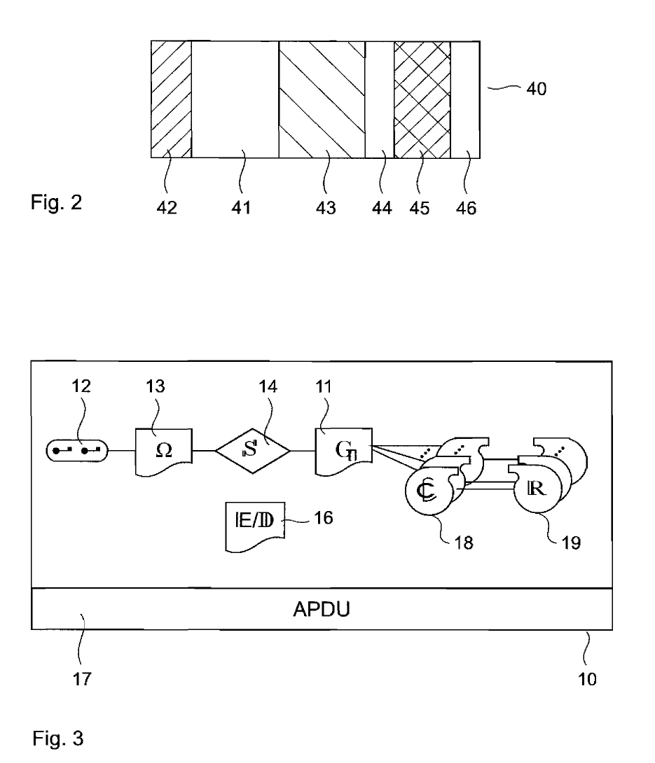

In FIG. 2 the partitions resident in the non-volatile memory 40 are schematically depicted. In the non-volatile memory 40 various partitions exist, comprising partitions of a boot monitor 42, the first application image 41, a second application image 43, configuration data 44, a file system 45, and a flash information system 46.

The boot monitor 42 is operational for starting up the mobile device 200. It allows the first CPU 20 to load the first application 1 that is stored in the first application image 41, or alternatively a second application stored in the second application image 43. The coexistence of the two application images 41, 43 allows update operations via the communication modules 60, 70. The second application image 43 is then used to received the first update of the first application 1 and the updated first application 1 receives a higher serial number. For the next update the first application image 41 receives the updated first application 1, receiving again a higher serial number. This use of the application images 41, 43 continues alternatingly. The boot monitor 42 is looking for the application with the highest serial number and will therefore pick automatically the most recently updated first application 1 for the next booting process.

The configuration data, and file system provide input to the first application. The configuration data can contain parameter settings determining which sensors to use, how often to check those sensors, but also when to send messages and alerts. In addition, parameters can be dependent on the current geographic location of the mobile device. Configuration data is usually stored in the file system in the non-volatile memory, but can also be stored directly in specially reserved areas of the non-volatile memory.

The flash information system 46 allows the boot monitor 42 to operate with symbolic addresses within the memory range of the non-volatile memory 40. This feature is helpful for developing applications, i.e. when the address range of the first application 1 is not yet fixedly determined. As such with a marketed mobile device 200 the flash information system 46 could be renounced.

In FIG. 3 the content of the smart card 10 is schematically illustrated. It comprises a private/public key pair 12 which is held in a place that provides a predetermined level of security in order to keep the intruder from accessing the private key thereof. The private/public key pair 12 is accessible by an electronic-signature applet 13. In addition the smart card 10 comprises the integrity applet 11 which has access to a set of challenge-response pairs, wherein for each challenge 18 a corresponding expected response 19 is stored. The result delivered by the integrity applet 11 is maintained in a state indicator 14. which is accessible by the electronic-signature applet 13 and an encoder/decoder applet 16. Furthermore the smart card has a serial interface 17 via which it communicates with the first CPU 20 e.g. via standard ISO 7816 APDUs.

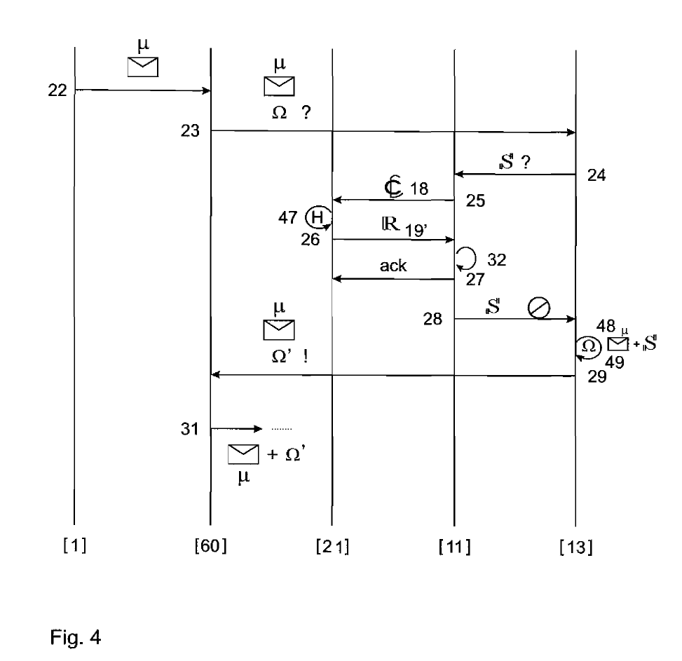

In the following, methods of exchanging messages μ between the mobile device 200 and the backend system 300 making use of the applets 13, 16, 11 of the smart card 10 are described. All those methods have a process in common that is herein referred to as a guardian process. This process is described herein upfront before the methods of FIGS. 4 to 7 are described in more detail. Hereinafter the integrity applet 11 is also referred to as guardian applet 11, and the integrity module 21 is also referred to as guardian module 21.

The guardian process works as follows: The guardian applet 11 on the smart card 10 communicates with the guardian module 21 of the first application 1 that is running on the first CPU 20. The guardian applet 11 sends an integrity challenge C_int to the guardian module 21. The integrity challenge C_int is accompanied by a request to the guardian module 21 to compute a hash value H, here in particular a cryptographic hash H(s,e), over an area of the non-volatile memory 40, wherein s denotes a start address within the non-volatile memory 40 and e denotes an end address of the area within the non-volatile memory 40. The start address s and the end address e hence define the area over which the cryptographic hash H(s,e) will be computed. For each integrity challenge C_int the guardian applet 11 has an expected response value R_exp. The guardian module 21 calculates the cryptographic hash H(s,e) over the indicated area (s,e) of the non-volatile memory 40 and returns its result R_app=H(s,e) to the guardian applet 11. The integrity challenge C_int is satisfied if R_exp=R_app. This equation is checked by the integrity applet 11 on its result S.

The guardian applet 11 keeps track of the results S of the (R_exp=R_app) equality check as follows: It updates the status of a Boolean variable app_integer=app_integer & (R_exp=R_app), with app_integer starting out as being true. Thereby the Boolean variable app_integer serves as an integrity flag. Once it is set on the value False it can not return to the value True. The guardian applet 11 does not communicate the result S of the (R_exp==R_app) equality check to the guardian module 21.

The above process is used to monitor preferably the integrity of the first application image 41. The first application image 41 is considered to be integer as long as the guardian module 21 is able to provide a result R_app back to the guardian applet 11 such that R_exp=R_app. It is also possible to monitor by this process the integrity of the second application image 42, or of any combination of the first application image 41 and the second application image 42. A preferred embodiment checks both application images 41, 42 together.

Each smart card 10 can have multiple integrity challenges C_int stored on it. Also, each smart card 10 issued can have a unique set of integrity challenges C_int, so that no two smart cards 10 will have the same set of integrity challenges C_int. The probability of two smart cards 10 having the same integrity challenges C_int depends on the size of the first application image 41. In addition for the integrity check it is advantageous to pad out the first application image 41 so that its size is always larger than the size of free memory within the non volatile memory 40. “Padding out” here means to set the start address s and the end address to an area that is larger than the exact size of the first application image 41. In a preferred embodiment this area is larger than half the size of the available non-volatile memory 40. Both of these measures prevent an intruder from deceiving the integrity applet 11 by returning pre-computed values or simply storing a copy of the first application image 41 in the free part of the non volatile memory 40 and satisfying the integrity challenges C_int from the stored copy. This above described process allows to determine whether the first application 1 is still integer.

A second process utilizes the integrity flag, i.e. the app_integer variable on the smart card 10, to influence the outcome of signing, encoding and decoding operations: When the integrity flag app_integer is False, that is, one of the integrity challenges C_int was failed by the first application 1, the outcome of a cryptographic operation is falsified. For example, when the first application 1 asks the smart card 10 to generate a signature Ω, then the smart card 10 will not generate the signature Ω without checking the status of the integrity flag app_integer. If the integrity flag app_integer is False, the smart card 10 generates a false signature Ω′ and includes in that signature Ω′ information about the failed integrity challenges C_int. Thus, the signature Ω is used as a covert channel to signal to the backend system 300 that the first application image 41 was tampered with. The signature Ω is created by using a cryptographic key, which could for instance be the private key of the smart card 10. Before sending, the message μ can be encrypted. For this, the private key of the smart card 10 can be used. Hence, the signature Ω and the encryption of the message μ can both be performed using the same key, and both be performed by the smart card 10. In this case, the first application 1 can not check on the content of the message μ such that the message μ can be amended before sending, in a preferred embodiment using the result S of the equality check step 32. Alternatively the message μ can be encrypted on the smart card 10 using the public key of the backend system 300. This result S can for example be added to the original message μ before encrypting and sending. Also, to reduce power consumption on the side of the smart card 10, encryption of only the result S could be performed by the mart card 10, this encrypted result S can be added to the original message μ which then is encrypted by the first application 1 using another cryptographic key such as the public key of the backend system 300.

In FIG. 4 a flowchart of a method for sending a message from the mobile device 200 to the backend system 300 with a tampered first application 1 is illustrated.

In a send request step the first application 1 sends to the first communication module 60 a message μ to be transmitted to the backend system 300. The first communication module 60 requests this message μ to be signed by the electronic signature applet 13 with a signature Ω in a signature request step 23. Thereupon the electronic signature applet 13 sends in a status check step 24 to the integrity applet 11 a request about the integrity status S of the first application image 41. In a challenge step 25 the integrity applet 11 sends the integrity challenge 18 to the integrity module 21. Then the integrity module 21 computes in a response computation step 47 a response 19′. In a response step 26 the response 19′ is sent from the integrity module 21 back to the integrity applet 11, where in an equality check step 32 the received response 19′ is compared with an expected response 19. In an acknowledgment step 27 the integrity applet 11 sends an acknowledgment back to the integrity module 21 without notifying the integrity module 21 of the result S of the equality check step 32. Hence the integrity module 21 has no indication whether it has responded with the correct, expected response 19. In a status report step 28 the integrity applet 11 does communicate the result S of the equality check step 32 to the signature applet 13. Based on this result S the signature applet 13 performs a signature step 49 with or without a message amendment step 48. In the event of a positive result 5, i.e. the expected response 19 was identical to the received response 19′, the message μ is signed without amendment. In the event of a negative result 5, i.e. the expected response 19 was not identical to the received response 19′, the message μ is altered before the signature step 49. Such alteration or amendment can be designed in different ways. For instance the signature applet 13 can append a submessage to the message μ, wherein the submessage tells that the expected response 19 was not identical to the received response 19′. Also, the message μ could be changed e.g. by scrambling its information. Other amendments are also feasible. Eventually, the message μ is signed in the signature step 49 in any event. For sake of understandability herein, the signature Ω to the message μ in the case of an altered first application image 41 has here been designated as Ω′, although to the first communication module 21 which is the first recipient of that signed message μ there is no difference visible towards a signature Ω in the event of an untampered first application image 41. Thereafter the message μ with its signature Ω′ is forwarded in a signature forwarding step 31 to the first communication module 60. Finally the first communication module 60 in a send step 31 sends the signed message μ+Ω′ to the second communication module 70. In the backend system, the message μ is readable and the amendment is also detectable. The mobile device 200 has hence served as a conduit for the message μ communicating lack of trustworthiness of the mobile device 200 due to the recognized altered first application image 41.

Hence, to summarize this process, when the first application 1 wants to send a message to the backend system 300 it sends it to the first communication module 60. The first communication module 60 then asks the smart card 10 for the electronic signature Ω for which the smart card 10 holds its public/private key pair 12. Before signing the data, the smart card 10 checks the integrity of the first application 1. It activates the guardian applet 11 which uses the described challenge-response process to acquire an update of the integrity flag app_integer. If the integrity flag app_integer remains true, the electronic-signature applet 13 is notified thereof and will then sign the data for sending it to the backend system 300. In the event the integrity flag app_integer is false, the guardian module 21 receives still an acknowledgment, but the electronic signature applet 13 will be notified that the first application 1 is not integer. The signer then introduces an alert information in the message μ, then signs it and provides it for sending to the backend system 300. The message transports with itself an alert message to the backend system 300. The mobile device 200 will have no possibility to realize it has been tracked as malicious, and will serve as conduit for information about its own maliciousness.

If the mobile device 200 instead elects not to send any data back to the backend system 300, to obstruct its own maliciousness, the backend system 300 will receive no more data. It is advantageous to design the messaging protocol between the backend system 300 and the mobile device 200 in a way that the backend system 300 expects a specific message, also referred to as heartbeat message or alive message, within certain time intervals. The absence of such a heartbeat message will then be interpreted as either a system failure or a malicious mobile device 200 in both cases of which the backend system 300 will no longer send information to the mobile device 200.

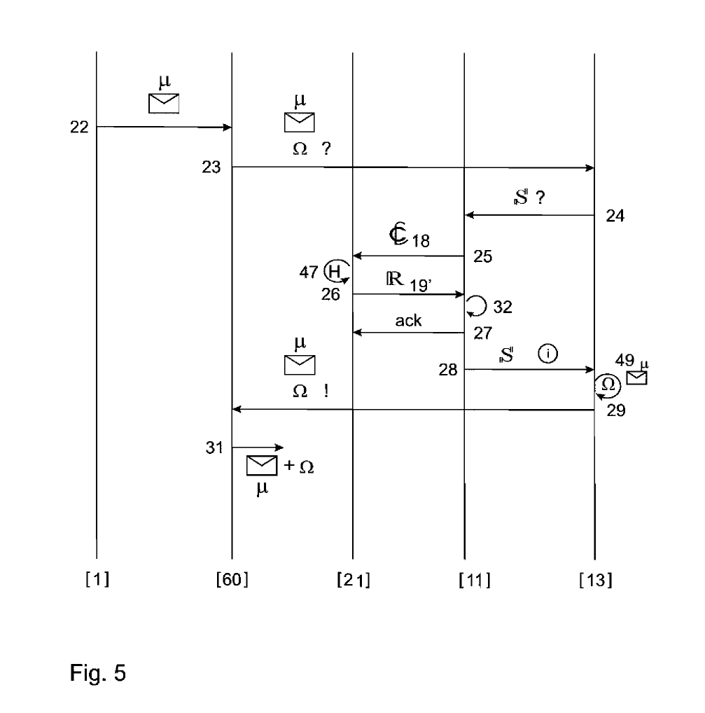

In FIG. 5, a flowchart of a method for sending a message from a mobile device to a backend system with an untampered application is illustrated.

In a send request step the first application 1 sends to the first communication module 60 a message μ to be transmitted to the backend system 300. The first communication module 60 requests this message μ to be signed by the electronic signature applet 13 with a signature Ω in a signature request step 23. Thereupon the electronic signature applet 13 sends in a status check step 24 to the integrity applet 11 a request about the integrity status S of the first application image 41. In a challenge step 25 the integrity applet 11 sends the integrity challenge 18 to the integrity module 21. Then the integrity module 21 computes in a response computation step 47 a response 19′. In a response step 26 the response 19′ is sent from the integrity module 21 back to the integrity applet 11, where in an equality check step 32 the received response 19′ is compared with an expected response 19. In an acknowledgement step 27 the integrity applet 11 sends an acknowledgement back to the integrity module 21 without notifying the integrity module 21 of the result S of the equality check step 32. Hence the integrity module 21 has no indication whether it has responded with the correct, expected response 19. In a status report step 28 the integrity applet 11 does communicate the result S of the equality check step 32 to the signature applet 13. Based on this result S the signature applet 13 performs a signature step 49 with or without a message amendment step 48. In the event of a positive result 5, i.e. the expected response 19 was identical to the received response 19′, the message μ is signed without amendment. In the event of a positive result 5, i.e. the expected response 19 was identical to the received response 19′, the message μ is not altered before the signature step 49. Eventually, the message μ is signed in the signature step 49 in any event. Thereafter the message μ with its signature Ω is forwarded in a signature forwarding step 31 to the first communication module 60. Finally the first communication module 60 in a send step 31 sends the signed message μ+Ω to the second communication module 70. In the backend system, the message μ is readable.

Another event is the processing of incoming information.

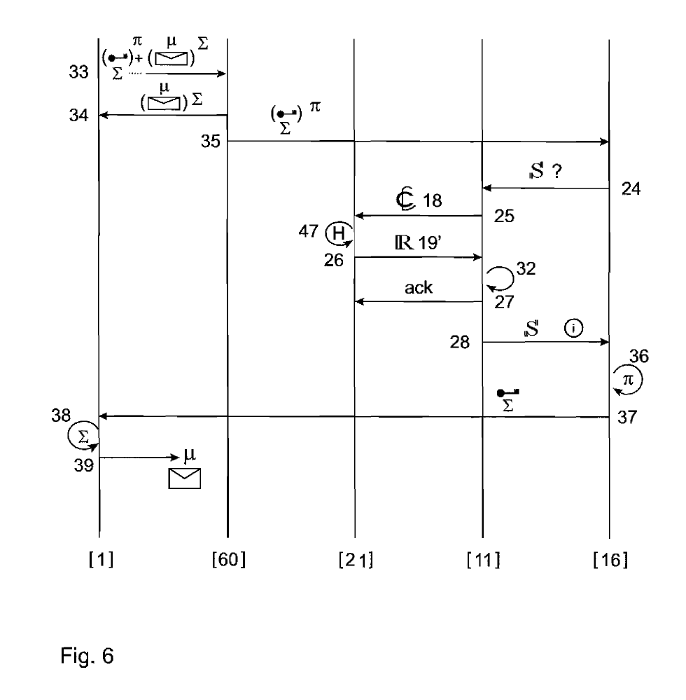

In FIG. 6, a flowchart of a method for receiving a message μ at the mobile device 200 from the backend system 300 with an untampered first application 1 is illustrated.

In a message reception step 33 a message μ that is encrypted with a session key Σ is received at the first communication device 60. The message μ is accompanied by the session key Σ being encrypted itself with the public key π of the private/public key pair 12. The session key Σ is here a symmetric cryptographic key. Such encryption is also referred to as hybrid encryption. To read the message μ the first application 1 needs the session key Σ to be unpacked, i.e. decrypted. The first communication device 60 forwards the encrypted message μ in a message forwarding step 34 to the first application 1, and the encrypted session key Σ in a session key unpack request step 35 to the encoder/decoder applet 16. Before performing any decoding the encoder/decoder applet 16 performs the challenge/response process.

The encoder/decoder applet 16 sends in a status check step 24 to the integrity applet 11 a request about the integrity status S of the first application image 41. In a challenge step 25 the integrity applet 11 sends the integrity challenge 18 to the integrity module 21. Then the integrity module 21 computes in a response computation step 47 a response 19′. In a response step 26 the response 19′ is sent from the integrity module 21 back to the integrity applet 11, where in an equality check step 32 the received response 19′ is compared with an expected response 19. In an acknowledgement step 27 the integrity applet 11 sends an acknowledgement back to the integrity module 21 without notifying the integrity module 21 of the result S of the equality check step 32. Hence the integrity module 21 has no indication whether it has responded with the correct, expected response 19. In a status report step 28 the integrity applet 11 does communicate the result S of the equality check step 32 to the encoder/decoder applet 16.

In this example, the status check delivered a positive result, i.e. the first application image 41 has been found to be integer. Therefore the encoder/decoder applet 16 performs a session key unpack step 36 in which the session key Σ is unpacked, i.e. decrypted using the private key of the private/public key pair 12. The result is a decrypted session key Σ. In a session key forwarding step 37 the session key Σ is then forwarded to the first application 1. There, the received session key Σ is used to decrypt the message μ. Finally the decrypted message μ is utilized by the first application 1 in a message use step 39. Examples of use of such message μ could be to update the first application 1, to enhance its functionalities, install new driver software, fix code bugs, reset certain information, delete information, perform data operations, etc.

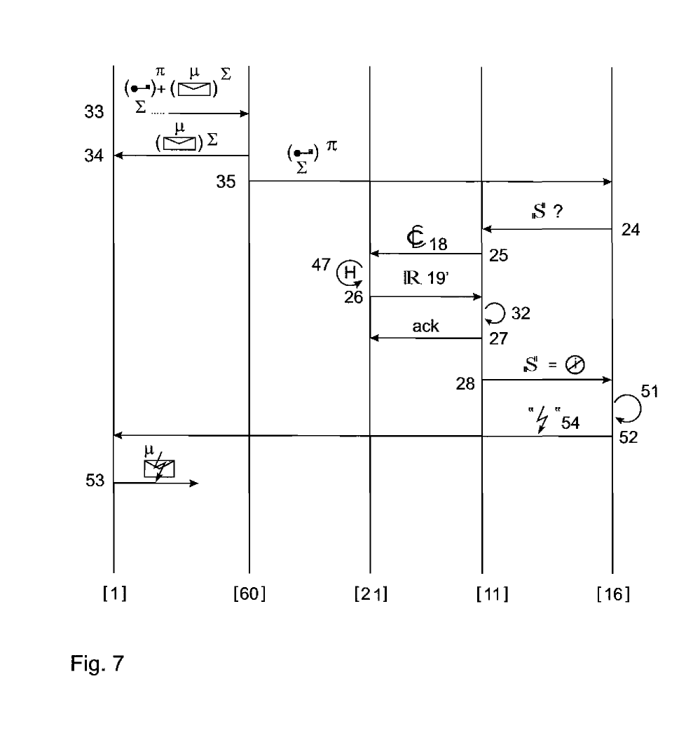

In FIG. 7, a flowchart of a method for receiving a message μ at the mobile device 200 from the backend system 300 with a tampered first application 1 is illustrated.

In a message reception step 33 a message μ that is encrypted with a session key Σ is received at the first communication device 60. Thereafter the process is identical to the process described in conjunction with FIG. 6, up and until again, in a status report step 28 the integrity applet 11 communicates the result S of the equality check step 32 to the encoder/decoder applet 16.

In this example, the status check delivered a negative result, i.e. the first application image 41 has been found not to be integer. Therefore the encoder/decoder applet 16 performs an error generation step 51 in which instead of unpacking the session key Σ an error message, also referred to as pseudo message 54 is generated. This pseudo message 54 is sent to the first application 1 in an error forwarding step 52 and pretends to the first application 1 that the received message μ is corrupt. Thereby the first application 1 again does not learn that it is the fact that it has been recognized as tampered with that has actually prevented the revealing of the message μ to the first application 1. Hence, the first application 1 gets no incentive to change its behavior because its lost integrity has been detected. It is hence prevented that the non-integer first application 1 receives the content of the message μ.

To summarize the reception mechanism, in the event the mobile device 200 receives a message μ that is encoded with the session key Σ, and the session key Σ is itself encoded by the public key of the smart card 10, in the smart card 10 its private key is used to unpack the session key Σ. Then the session key Σ could be forwarded to the first CPU 20 for decoding the encoded message μ. Before doing that the smart card 10 checks the status of the integrity flag app_integer. In the event the integrity flag app_integer is false, instead of forwarding the session key Σ to the first CPU 20 for decoding the message μ, the smart card 10 returns an error to the first CPU 20 and pretends that it received a non-decipherable message μ. Thereby the first CPU 20 is prohibited from receiving information via the message μ because the first application 1 has been identified as malicious. By hiding the detection of non-integrity from the CPU 20 the CPU 20 is likely to continue its service, in particular the messaging service to the backend system 300, such that the backend system 300 can be provided with the information that the CPU 20 has been tampered with. This process hence allows to both protect incoming data from being revealed to unintended recipients, i.e. the attacker, and to signal back to the backend system 300 that the first application image 41 has been tampered with.

The above method also works with a pure public/private key encryption of the whole message μ. However this would mean that the smart card 10 is used for decrypting the whole message μ which would mean to provide electrical power to the smart card 10 during the whole decrypting operation and which would take longer due to the more limited capacity of the smart card 10 in comparison to the first CPU 20. The session key Σ is hence useful in that it allows the first CPU 20 to do the decoding using the session key Σ without involving the smart card 10 therefore. The use of the public/private key pair 12 for packing the session key Σ allows the smart card 10, however, to take control over the session key Σ, and only to reveal it to the first CPU 20 once the first CPU 20 has been verified on its integrity.

Hence, the proposed method makes use of a series of integrity challenges 18 that are stored on the smart card 10. Independently from the process of running the challenge/response process when sending or receiving a message μ, the guardian applet 11 running on the smart card 10 can be designed to at various points in time issue a—preferably randomly chosen—integrity challenge 18 to the first application 1. The first application 1 is expected to satisfy the integrity challenge 18 and as long as it can provide the correct response 19 to the integrity challenge 18, it is considered integer. Furthermore, the smart card 10 is usable to sign, decrypt and encrypt messages μ from the mobile device 200, e.g. an embedded system, to the backend system 300 using public/private key cryptography on the smart card 10 itself.

The advantages of this solution are: There is no need for a modified CPU 20 nor are the results of checksums stored inside the first application image 41 itself. Instead the smart card 10 is used as a more tamper-resistant component, acting as guardian. In addition, by providing for the external communication to be vetted by the smart card 10 communication is ensured to happen with the smart card 10 itself. Thus, an attacker could not just choose to ignore the smart card 10. With known smart card technologies, the smart card 10, and hence the data stored thereon can be designed to exhibit an increased level of security. The level of security of the smart card 10 is higher than that of the mobile device 200 without the smart card 10. The described techniques may be implemented as a method, apparatus or article of manufacture involving software, firmware, micro-code, hardware and/or any combination thereof. The term “article of manufacture” as used herein refers to code or logic implemented in a medium, where such medium may comprise hardware logic, e.g., an integrated circuit chip, Programmable Gate Array (PGA), Application Specific Integrated Circuit (ASIC), etc., or a computer readable medium, such as magnetic storage medium (e.g., hard disk drives, floppy disks, tape, etc.), optical storage (CD-ROMs, optical disks, etc.), volatile and non-volatile memory devices, e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc. Code in the computer readable medium is accessed and executed by a processor. The medium in which the code or logic is encoded may also comprise transmission signals propagating through space or a transmission media, such as an optical fiber, copper wire, etc. The transmission signal in which the code or logic is encoded may further comprise a wireless signal, satellite transmission, radio waves, infrared signals, Bluetooth, etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may comprise a combination of hardware and software components in which the code is embodied, processed, and executed. Of course, those skilled in the art will recognize that many modifications may be made without departing from the scope of embodiments, and that the article of manufacture may comprise any information bearing medium. For example, the article of manufacture comprises a storage medium having stored therein instructions that when executed by a machine results in operations being performed.

Certain embodiments can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, certain embodiments can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article. The functionality and/or the features of a device may be alternatively embodied by one or more other devices which are not explicitly described as having such functionality/features. Thus, other embodiments need not include the device itself.

Certain embodiments may be directed to a method for deploying computing instruction by a person or automated processing integrating computer-readable code into a computing system, wherein the code in combination with the computing system is enabled to perform the operations of the described embodiments.

Furthermore, many of the software and hardware components have been described in separate modules for purposes of illustration. Such components may be integrated into a fewer number of components or divided into a larger number of components. Additionally, certain operations described as performed by a specific component may be performed by other components.

Therefore, the foregoing description of the embodiments has been presented for the purposes of illustration and description. It is not intended to be exhaustive or to limit the embodiments to the precise form disclosed. Many modifications and variations are possible in light of the above teaching.

1. A method for sending a message from a mobile device via a first application running on said mobile device, the method comprising:
a challenge step for supplying the first application with a challenge,
a response step for receiving a response to said challenge,
an equality check step for determining whether the received response corresponds to an expected response,
a signature step for providing a signature for the message, using a cryptographic key and the result of the equality check step, and
a send step for sending the signed message via said first application from said mobile device to a backend system.

2. The method according to claim 1, wherein the message is modified in a message amendment step with the result of said equality check step, before the signature step.

3. The method according to claim 2, wherein the message is modified by adding the result of said equality check step to the message.

4. The method according to claim 1, wherein the signed message is sent in the send step via a first communication module of said mobile device.

5. The method according to claim 1, wherein the message is encrypted using the private key of the private/public key pair stored on a smart card.

6. The method according to claim 1, wherein the cryptographic key is held on a smart card.

7. The method according to claim 1, wherein the cryptographic key is selected to comprise the private key of a private/public key pair stored on a smart card.

8. A method for receiving a message at a mobile device via a first application running on said mobile device, the method comprising:
a message reception step for receiving said message in an encrypted form,
a challenge step for supplying the first application with a challenge,
a response step for receiving a response (19′) to said challenge,
an equality check step for determining whether the received response corresponds to an expected response,
if the result of said equality check step is positive, a message decryption step for decrypting the message, and
if the result of said equality check step is negative, an error generation step.

9. The method according to claim 8, wherein said encrypted form has been created under use of the public key of a private/public key set stored on a smart card.

10. The method according to claim 8, wherein said encrypted form has been created under use of a symmetric cryptographic key which is received together with the message, wherein the symmetric cryptographic key is received in encrypted form, wherein said encrypted form has been created under use of the public key of a private/public key set stored on a smart card.

11. The method according to claim 1, wherein the challenge and the expected response are selected from a set of predetermined challenges/expected responses.

12. The method according to claim 1, wherein the challenge step and the response step are executed by means of an integrity applet on a smart card.

13. The method according to claim 1, wherein the challenge step comprises a request to compute a hash value of a predetermined memory area in a memory of the mobile device.

14. The method according to claim 13, wherein said memory area is selected to comprise at least part of a first application image of the first application.

15. The method according to claim 13, wherein said memory area is determined by a start address and an end address, said memory area differing between different challenges of said set of predetermined challenges/expected responses.

16. The method according to claim 1, wherein the result of said equality check step, if negative, is maintained as a negative integrity flag (app_integer).

17. The method according to claim 1, wherein the first application is updatable via the first communication module of the mobile device.

18. The method according to claim 17, wherein the updated first application is stored in a second application image.

19. The method according to claim 17, wherein the updated first application is received together with an updated set of challenges/expected responses.

20. The method according to claim 1, further comprising an acknowledgement step wherein after the equality check step the reception of the response is acknowledged without communicating the result of said equality check step.

21. A computer program element comprising computer program code means which, when loaded in a processor of a data processing system, configures the processor to perform a method for sending a message from a mobile device via a first application running on said mobile device, the method comprising:
a challenge step for supplying the first application with a challenge,
a response step for receiving a response to said challenge,
an equality check step for determining whether the received response corresponds to an expected response,
a signature step for providing a signature for the message, using a cryptographic key and the result of the equality check step, and
a send step for sending the signed message via said first application from said mobile device to a backend system.

22. Mobile device comprising
a memory for storing therein a first application image of a first application,
a first processor adapted to compute a response to a received challenge,
a card reader for receiving from a smart card said challenge, sending the response, and receiving a signed message, and
a first communication module for sending the signed message to a backend system.

23. Smart card comprising stored therein
an integrity applet for executing
a challenge step for supplying a first application with a challenge,
a response step for receiving a response to said challenge,
an equality check step for determining whether the received response corresponds to an expected response, and
an electronic signature applet for executing
a signature step for signing a message, using a cryptographic key and the result of the equality check step, and
a signature forwarding step for forwarding the signature for the message to a first communication module.

24. Smart card according to claim 23, wherein the integrity applet is further adapted for executing an acknowledgement step wherein after the equality check step the reception of the response is acknowledged without communicating the result of said equality check step.

25. Smart card according to claim 23, further comprising a private/public key pair of which the public key is usable as the cryptographic key.

26. Smart card according to claim 23, further comprising a set of predetermined challenges/expected responses from which the challenge and its expected response are selectable.

27. Smart card according to claim 23, further comprising an integrity flag in which the result of the equality check step, if negative, is maintained.
